(19) United States
(12) Patent Application Publication
(10) Pub. No.: US 2002/0196953 A1
(43) Pub. Date: Dec. 26, 2002

(54) Swimmers ear

(76) Inventor: Andrew John Burke, Preston, MD (US)

Correspondence Address: Andrew John Burke, 232 Main St., P.O. Box 426, Preston, MD, 21655-0426, US

(21) Appl. No.: 10/057,515

(22) Filed: May 28, 2002

Related U.S. Application Data
(60) Provisional application No. 60/267,380, filed on Feb. 9, 2001.

(51) Int. Cl. H04R 1/10; H04R 5/02; H04B 1/034

(52) U.S. Cl. 381/309; 381/311; 381/74; 381/384; 455/575; 455/100

(57) ABSTRACT

The Swimmer's Ear is an electronic device that allows a swimmer or bather a means to safely listen to music while engaged in water activities. This invention is unique in that it allows universal use of any existing electronic devices equipped with a headphone jack. The two part Swimmer's Ear will attach itself via a headphone jack to an existing electronic device such as a CD or MP3 player and transmit to the listener the music or sound. The receiver will be powered by a power source inside a waterproof housing. This receiver will allow the listener to attach it to one's head by means of a clip for any swimming goggles or headband The materials used for this invention are currently in use such as: durable plastics, radio frequency transmitter and receiver, waterproof housings.

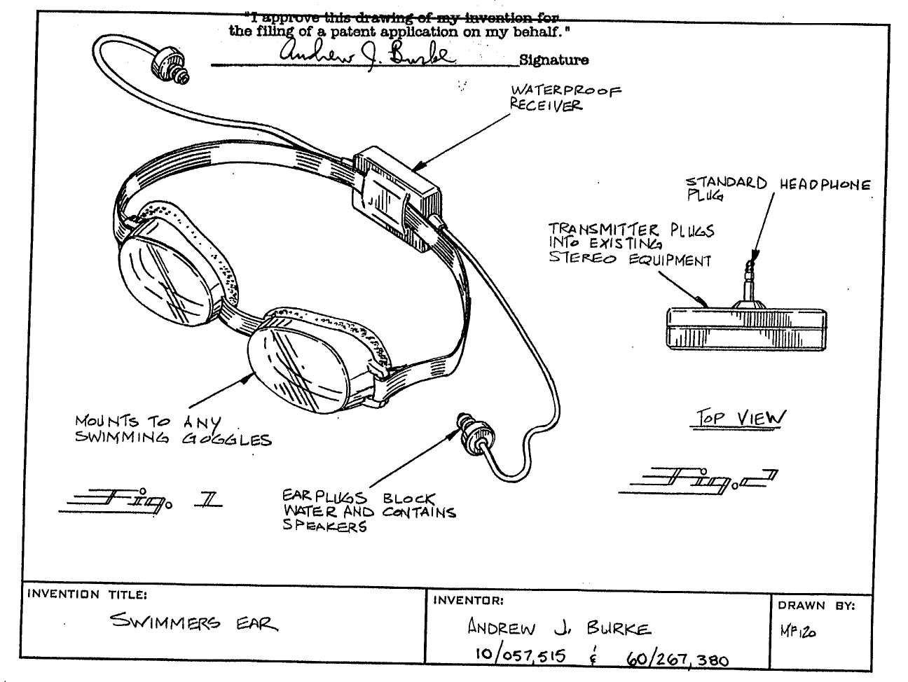

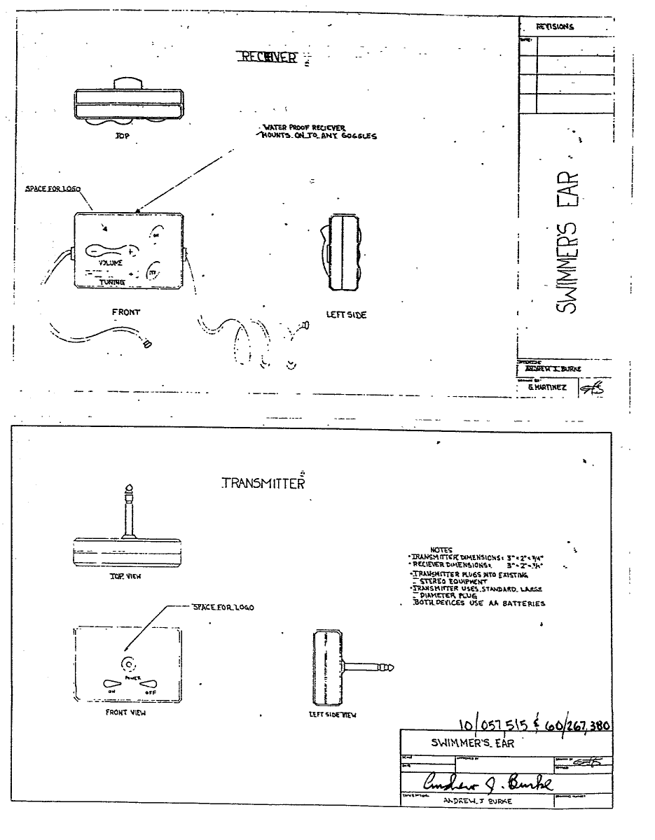

### INTRODUCTION

This New Product Portfolio has been specially developed in the United States by Patent & Trademark Institute of America (PTI), at the request of the Inventor Andrew J. Burke of Preston, Maryland. The name of the Invention is Swimmers Ear.

PTI has conducted an explanation of product considerations which includes information provided by the Inventor and by PTI's research departments and consultants assigned to this project. This report includes economic data and an analysis related to specific industries.

The statistical classification system used in this report follows the U.S. Department of Commerce Standard Industrial Classification Code System (SIC). The SIC system was originally developed by the Department of Labor to classify industries. The SIC codes describe industries but does not describe occupations which people hold within those industries.

In addition, we also use the newly developed North American Industry Classification System (NAICS). The NAICS was developed jointly by the United States, Canada and Mexico to provide new comparisons of statistics regarding business activities across North America. These codes systemically divide economic activities into broad divisions (manufacturing, mining, retail, trade, etc.). Each division is broken down into major industry groups (two-digit), then into industry sub-groups (three-digit) and into industries (four-digit). The numbering system provides flexibility and permits use of the classification at various levels of detail according to specific needs. Industry management utilizes the SIC and NAICS for economic forecasting, marketing analysis, allocation of advertising budgets and company identification.

In preparing your New Product Portfolio, we utilize a wide variety of statistical information. The U.S. Department of Commerce and the Bureau of the Census prepare much of this material. Other sources we use include trade publications, marketing reports, commercial information services and the Internet. We generally rely on government-generated figures because they are by far the most accurate and unbiased data available.

While any company that may become interested in your idea would likely have an understanding of these fundamental statistics and marketing principles, your New Product Portfolio gives them a clear understanding of your invention. In addition to clearly communicating the concept, features, benefits and need for your invention, the portfolio provides important marketing information that new product managers may not have readily available.

### HISTORICAL DEVELOPMENT AND ADVANTAGES

This section of the portfolio reviews the invention as submitted by the Inventor. The concept is captured in a clear, concise statement and the invention is described.

A concept is a vision of how an invention would look and perform; a product invention is a tangible item. In order to sell new products, it is important that the concept and the invention be merged.

PTI is pleased to present Swimmers Ear, as invented by Andrew J. Burke of Preston, Md.

To assess any new product's future acceptance and popularity, one should research the background and the need of such an innovation. This section addresses the background of the idea's conception and the problem(s) it is designed to ease or eliminate.

In order to maintain their physical fitness, a large number of people work out on a regular basis. Some people choose to run, walk, jog or swim. Others use exercise machines such as stationary bicycles, treadmills, rowing machines or stair-climbing machines.

However, working out can often become boring. To alleviate the boredom, some people watch television shows or movies that can be played on a VCR. In addition, one can also listen to the music from a radio, a CD player or a radio. However, these products are hard to use when one is swimming in a swimming pool.

A new Invention, Swimmers Ear, would provide an innovative alternative to conventional methods of listening to music in the form of a specially designed transmitter/receiver system designed to be used by swimmers. It would provide entertainment when one was exercising in a swimming pool, would be produced from high-quality, durable materials and could be easily stored when not in use.

Swimmers Ear would be marketed to consumers of all ages. A possible secondary market would be health clubs and spas.

The purchase of such an item as Swimmers Ear is dependent upon the level of discretionary purchasing power, which is the portion of a consumer's income remaining after necessities such as housing, transportation and food have been accounted for. About 60 percent of after-tax income is spent on these fixed expenses. The remaining 40 percent is spent on variables. According to the U.S. Census Bureau's March 1997 Current Population Survey, discretionary income totals nearly $480 billion, which is about 19 percent of the total after-tax income received by the average household. This is an increase of 17 percent over 1996.

An overview of the economy of the U.S. in general and an analysis of the manufacturing industries associated with the Swimmers Ear in particular are appropriate in reviewing this product. According to the Journal of Business and Industrial Marketing, “Industrial firms must continue to create innovative products despite high new product introduction risk; they may otherwise face loss of market shares.” A survey of 900 companies found they would likely derive 33 percent of their profits over several years from new products.

The U. S. economy is in a period of growth. Important consequences of this growth include an increase in capital spending, resulting in greater manufacturing capabilities and higher consumer disposable income, which gives consumers the ability to spend more money on products they want, rather than just on products they need. These factors help to create the environment into which many new product ideas are effectively introduced.

Several other issues of concern are the renewal of the Generalized System of Prevercences (GSP) program, the recently enacted North American Free Trade Agreement (NAFTA) and the continuation of negotiations of the General Agreement on Tariffs and Trade (GATT). The GSP is important to many companies in the plastic industry, as several products are labor-intensive and too costly to be made in the United States. However, for the products that are manufactured here, easing and removing market barriers are key concerns because U.S. exports account for 0.81% of product shipments in this industry. The enactment of NAFTA and a successful conclusion of the GATT negotiations should lower foreign tariffs and improve protection of intellectual property rights (e.g. patents, trademarks and copyrights).

With the implementation of NAFTA, free trade area between the United States, Canada and Mexico has been created. Within NAFTA, there are provisions for progressive elimination of tariffs on merchandise that qualifies as North American under its rules of origin. This creates a favorable environment for Swimmers Ear, as it exposes the invention to a greater number of manufacturers.

Many products today enjoy worldwide distribution. The interdependence of nations, growing import/export trade and expanding common markets have drawn our world together in both buying habits and product utilization. With more liberal trade policies and increased freedom of travel, the interest in foreign markets is bound to increase. U.S. exports as a whole are expected to rise 1% to 3% in the next year because more than half of these exported products go to areas where growth is ranging from good to excellent. Exports to Pacific Rim countries, not including Japan and China, have risen 9 percent in 1999. Shipments to China are up 23 percent and Canadian shipments have increased 11 percent. Shipments to Latin America are up 19 percent. In 1997, the U. S. exported to Canada an excess of $3.7 billion in plastic products alone. Exports to our southern neighbor Mexico were valued at $1.9 billion.

Commerce Department analysts expect exports of goods and services to remain an important source for growth. The volatility of the U.S. dollar's foreign exchange value from 1992 to the present, including record highs and lows against the German deutschmark and the Japanese yen, will reinforce the ability of U.S. industries to compete overseas, especially in the plastic industry.

### INVENTION DESCRIPTION & FUNCTIONAL OVERVIEW

To facilitate one's comprehension and understanding of a new product, that idea must be described not only as it exists as an answer to a subsistent problem, but also as it functions physically. Incorporated into this overview is a description of the invention's physical appearance.

Based upon the Inventor's description and our outside research, we will describe the basic overall features, shape and design of Swimmers Ear. Materials of which the invention would be produced will also be described.

The design of Swimmers Ear calls for plastic, rubber, metal, electrical components and electronic components to be used as its major components.

Swimmers Ear would consist of two components: a transmitter and a receiver.

The transmitter of Swimmers Ear would have a large, rectangular plastic housing and would be designed to plug into a CD player, a tape player or a portable radio using the existing jack on these products. The transmitter would have an infrared transmitter and a stainless steel plug that could fit into a jack.

The receiver of Swimmers Ear would consist of a small, rectangular plastic housing. The housing would be equipped with an infrared receiver, a battery compartment and two long cords with rubber earphones that would fit into the wearer's ears to create a watertight seal. Other features of Swimmers Ear would include two rubber straps which would allow Swimmers Ear to be attached to the flexible headband of a pair of clear plastic swimmers' goggles.

The plastic components of Swimmers Ear could be constructed with the use of injection molding or blow molding. Injection molding is a process that has been in use since the 1920s and provides a versatility almost unmatched in the mass production of any material. It requires that melted plastic be forcefully injected into relatively cool molds. As the plastic begins to harden, it takes on the shape of the mold cavity and, when cool, requires few postmolding operations. Other advantages of this process include its speed of production and the ability to simultaneously manufacture multiple parts.

Blow molding in the production of plastic shapes is a form of extrusion, a major technique in the plastics industry. Extrusion is used to push a molten tube, called a parison, into a bottle-shaped mold. Compressed air then forces the parison against the cold walls of the mold, hence the term “blow molding”. Molds are generally side fed, with the thickness controlled by a tapered mandrel (core) or a variable-orifice die. Continuous extrusion is possible by the use of multiple blow molds.

To use Swimmers Ear, a swimmer would plug the transmitter into the jack on a CD player, AM/FM radio or tape player, put on the goggles and fit the earphones into the ears before entering the water. When in use, music or a radio broadcast would be designed to travel from the transmitter to the receiver so that it could be heard by a swimmer. After use, Swimmers Ear could be removed.

Swimmers Ear could also be purchased by health clubs and spas. This version of Swimmers Ear could be supplied with multiple receivers so that a receiver could be provided to each customer.

### Proposed Modifications

In order to fully appreciate the benefits and need of an innovation, one should consider any possible modifications that would arise from the use of the idea.

PTI, therefore, shall suggest other applications of Swimmers Ear that would merit future consideration and study. The scope of this review may include the use of materials other than those specified by the Inventor. In addition, this review may support the use of additional materials, color schemes, diversified applications, broader consumer outlets or other possible shape and design alterations that may enhance the utility and salability of the invention. All in all, we shall attempt to identify any variations that would further define the scope of the idea.

One must remember, however, that these modification suggestions are limited within the latitude of the invention. Some inventions lend themselves easily to future applications, i.e. different shapes, materials, color schemes, etc. Other inventions, however, are geared to a specific group of consumers, to one particular design or to a strict manufacturing process. As a result, any suggested modifications to the invention may be limited within the invention's scope.

The following modifications are suggested to augment the usefulness and popularity of Swimmers Ear. It should be noted that these and/or other suggested modifications or variations of your invention will not be included in your preliminary patent art.

Swimmers Ear would require some modifications before it could function as the Inventor envisions. First, it would be necessary to substitute a radio transmitter and a radio receiver for the infrared transmitter and receiver. Infrared light beams would not be able to travel through water if a swimmer was swimming underwater and could be interrupted each time water rose over the receiver. A radio transmitter/receiver system would be more reliable and would function even if a swimmer was underwater.

Second, a stainless steel antenna would need to be added to the transmitter and to the receiver so that the radio signal could be carried from one to the other. The stainless steel antenna could be covered with neoprene rubber to protect it from the chemicals added to the water of the swimming pool.

Third, a volume control dial and an on/off switch should be added to the receiver. These components would provide a swimmer with improved control over the volume and the power of the receiver and could be encased in a clear plastic cover with a rubber gasket to prevent water seepage. The cover could be hinged at one side to allow the cover to be lifted upward to provide access to the volume control and on/off switch.

The plastic components of Swimmers Ear might be manufactured from PVC, ABS or polycarbonate plastic, which would be durable, strong, lightweight and relatively inexpensive to use. Care should be taken, however, that the plastic selected for Swimmers Ear would be able to withstand constant exposure to a humid environment and chlorinated water.

The rubber components of Swimmers Ear could be made from neoprene, nitrile or butadiene rubber. These materials would be durable and could be easily produced in the required form.

The metal components of Swimmers Ear might be created from Type 303 or 304 stainless steel. Common physical characteristics of these metals are good to high tensile strength and good to high corrosion resistance.

The Inventor suggests that Swimmers Ear could be accompanied by a swim cap. The swim cap could be produced from a flexible latex rubber and could have a chin strap with a Velcro strip to ensure that the cap would remain in position.

The Inventor notes that Swimmers Ear could be offered in various colors. Colors that might prove popular would be blue, red, green, pink, tan, black and yellow. These colors could be dyed into the plastic components of Swimmers Ear prior to molding.

In addition, detailed diagrams and technical specifications remain to be created. Nonetheless, there is a clear idea of the Inventor's intent and goals in submitting this design.

Overall, the basic concept behind Swimmers Ear appears to be sound and the product idea is workable. The basic materials are readily available and the concept of a convenient transmitter/receiver system that could be used by a swimmer to listen to music while he or she was swimming would appear to appeal to a vast variety of people. The design features in Swimmers Ear seem well within the limits of present-day technology.

Given the previous description of how the invention would function and taking into consideration the questions facing further development of Swimmers Ear, it is our tentative judgment that the idea is based on sound principles and that a production version of this item could be developed to perform generally as the Inventor states.

Potential problems that might arise during the development of Swimmers Ear should be amenable to resolution through normal product testing and refinement processes, after which we would anticipate the product could be produced routinely. However, we also recommend that an interested company should be allowed to do their own form of testing and marketing and to provide modification suggestions.

### Research and Development

There are various options available to manufacturers in research and development activities.

When a company considers a new product, they may wish to assume the additional responsibility for conducting research and development activities. This can be done either in-house or by contract with an independent research laboratory. In some instances, an interested company may wish to test a product under the terms and conditions of an option agreement with the Inventor. Options agreements generally allow the company to conduct their own R&D activities for a specified period of time and may involve a negotiated fee to be paid to the Inventor. The company is then better able to determine further licensing or purchasing interest.

### Production Considerations

We now turn to an examination of Swimmers Ear through a study of production considerations. We also shall briefly discuss the need of engineering guidance, materials, styles, sizes, etc.

Companies interested in a new product consider many factors which influence the production of the product. Technology, materials, labor, overhead and financial commitment are some of the key factors involved in decision making.

Our review of Swimmers Ear indicates that it can be manufactured using standard production of similar products. Materials, processes and even construction techniques would be similar, with adaptations made for the specific design of Swimmers Ear. Variations on the basic model would vary in price depending upon the cost of their specific components. The material submitted by Andrew J. Burke for Swimmers Ear seem to meet the standards set by the U.S. Government, i.e. OSHA, EPA, UL, etc.

In today's environment, the materials which are used in factories are of considerable importance. With the public awareness of clean air, clean water and pollution, the laws governing these areas are strictly enforced. Companies, especially in the plastic industry, are very cautious when it comes to using material not environmentally approved. The materials recommended by the Inventor for Swimmers Ear do not at this time appear to be problematic.

The components of Swimmers Ear utilize standard production technology. No new research or development in this area is anticipated, nor is major retooling or materials expense expected. In effect, this provides the company with lower start-up costs, which is a major consideration for product development.

Overall, since this product appears to be well thought out and workable, there should be little added research or development required for the production phase of Swimmers Ear.

The design is innovative and yet relatively simple. Existing production processes and techniques will suffice without resorting to new technology. Based upon our review of the material submitted by Andrew J. Burke, it is our tentative conclusion that this product can be manufactured from conventional and commercially available materials with existing production technology.

### Product Pricing Estimates

Perhaps the most critical area in the marketing mix involves price. No other decision has such a direct impact on sales revenue. It is virtually impossible to determine the precise cost of an undeveloped new product concept, since there are many unanswered questions.

Once an estimate of the cost of producing an item has been determined, consideration must be given to the type of mark-up structure most feasible for a particular item in order to determine final retail price. Pricing is a complicated process and must take into consideration the costs to manufacturers, wholesalers and/or distributors and retailers. There must be a margin of profit on all levels, over and above the costs incurred at each stage.

Before companies determine their pricing, they must include the fixed cost associated with their industry and with the particular item to be manufactured. Both production and marketing considerations encompass a wide range of variables. The following outlines are some of the significant factors involved in arriving at these cost estimates for Swimmers Ear.

### Manufacturing/Production Considerations

Raw Material Cost

Shipping & Handling Costs

Engineering and Design Costs

Tooling/Machinery and Equipment Costs

Labor Costs

Overhead and Profit

Loss, Warranty Reserves and Product Liability Insurance

Packaging

Direct/Indirect Cost Factors

Marketing Considerations

Test Marketing Campaigns

Market Research Surveys

Advertising Options

1-Television Commercials

2-Television Infomercials

3-Radio

4-Print Media

A. Newspapers

B. Magazines

C. Trade Journals

Promotional Strategies

1-Retail Promotion

2-Direct Mail Campaigns

3-Catalog Sales

Pricing Estimates

For the purpose of this “New Product Portfolio”, we can assume the following costs based upon current economic conditions on a single unit or per piece cost.

| | |
|---|---|
| Estimated Manufacturing Costs | $37.49 |
| Wholesale Price | $74.99 |
| Suggested Retail Price | $149.99 |

### Packaging Considerations

Packaging offers the manufacturer an important promotional medium, particularly when many of the products are similar and difficult to differentiate. Packaging is one of the dominant forces in a consumer's choice when making a purchase. The importance of the promotional impact of packaging is reflected in the battle by manufacturers to obtain shelf facings in retail stores. Thereafter, the package design that attracts the consumer's attention is an important medium at the time of purchase, which is why it is important to pay equally great attention to the package as well as to the product. A package is an advertisement for the product it contains. It must send a clear message, easily reproduced in visual media. Graphics, superimposed on a package, begin to shape the product's personality. For mass-distributed products that are displayed on shelves, both the graphics and the package often send additional messages to consumers more often and with more continuity than all forms of traditional advertising exposure.

The packaging decision must weigh four factors in the design phase:

(1) Marketing considerations,

(2) Product protection,

(3) Economic factors and

(4) Environmental factors.

The following chart extracted from Marketing a New Product; Its Planning, Developing and Control (Hisrich and Peters, 1994) provides some insight into complexity of packaging. Packaging is the responsibility of the manufacturer, not the Inventor.

### Marketing Considerations

| | |
|---|---|
| For Management | Product Protection |
| Recognition, Color/Size/Design | Prevention of Contamination |
| Image and Attitudes | Prevention of Physical Damage |
| Price Structure | Shelf Life (If Applicable) |
| Ease of Shipping | Safety Effects |
| For Retailer | Economic Factors |
| Shelf Stacking | Cost of Materials/Fabrications |
| Ease of Price Markings | Added/Reduced Manpower |
| Ease of Case I.D. | Inventory and Shipping Costs |
| Quantity of Packages per case | Availability of Raw Materials |
| Ease of Package Removal | Equipment Needs |
| Pilferage Protection | Competition |
| For Consumer | Environmental Factors |
| Consumer Convenience | Biodegradable |
| Ease of Storage | Opportunities for Recycling |
| Ease of Handling | Impact on Pollution |
| Direction for Use | Social Pressures |
| Reusability/Disposability | Legislative Pressures |
| Product Information | Impact on Natural Resources |
| Instructions for Use | |
| Expiration Date (If Applicable) | |

Packaging design consultants generally agree that product visibility has a strong impact on consumer selection of products and merchandise. Packaging design has become a science that measures consumer reaction. Color, for example, is one of the most important aspects of the package design. A product brand that uses a bold, bright color for an entire line of products will stand out much more on a retailer's shelves than another brand that uses different colors for different varieties. While bright colors may catch one's eye, specially marked packages with coupons will catch the attention of the “smart shopper” who is looking for value. Clever package design of Swimmers Ear can help to present the product more directly and impressively to the consumer.

1. What I claim as my invention, Swimmer's Ear, is a two part device that transmits a radio frequency originating from a transmitter with powered on/off switch that plugs into any existing stereo equipment via a standard headphone plug and a waterproof receiver with power, volume and tuning controls with waterproof earplugs that mount to any swim goggles via a clip.
